(19) United States
(12) Patent Application Publication
(10) Pub. No.: US 2008/0215506 A1
(43) Pub. Date: Sep. 4, 2008

(54) Systems and methods for a community-based e-consultant brokerage

(76) Inventors: Rajan T. Annadurai, Dayton, NJ (US); Siva Tamilmani, Madurai (IN)

Correspondence Address: Rajan T. Annadurai, 2402 Dahlia Circle, Dayton, NJ, 08810, US

(21) Appl. No.: 11/807,122

(22) Filed: May 25, 2007

Related U.S. Application Data
(60) Provisional application No. 60/808,669, filed on May 26, 2006.

(51) Int. Cl. G06Q 30/00

(52) U.S. Cl. 705/400; 705/1

(57) ABSTRACT

The present invention relates to systems and methods for requesting, receiving, providing, and paying for services over the internet, through IM and VoIP applications, and other communication means. According to a first preferred embodiment of the present invention, systems are provided that allow a customer to purchase and receive the services of a consultant. More particularly, such systems generally comprise (i) an instant messaging (IM) application, which is capable of connecting a customer to a consultant; (ii) an IM plugin, wherein the IM plugin is capable of detecting a message from the customer to the consultant sent through the IM application; and (iii) a server, wherein the server is capable of communicating with and receiving input from the IM plugin, wherein such input is processed by the server to validate the customer and instruct the IM plugin to connect the customer with the consultant through the IM application. The systems and methods of the present invention allow consultants to provide “micro-consulting” type services through IM applications and VoIP connections, whereby the consultants may be compensated for such services based on the length of the consulting session.

### CROSS-REFERENCE TO RELATED APPLICATIONS

This application claims priority to, and incorporates by reference, U.S. provisional patent application Ser. No. 60/808,669, filed May 26, 2006.

### FIELD OF THE INVENTION

The present invention relates to the field of e-commerce. More particularly, the present invention relates to systems and methods for requesting, receiving, providing, and paying for services using the internet, instant messaging applications, and through other mediums.

### BACKGROUND OF THE INVENTION

Websites like E-Bay (www.ebay.com) provide a marketplace for buyers and sellers of goods to interact and consummate transactions. E-Bay, and other similar websites, are primarily designed as a means to buy and sell tangible goods. In addition, other currently-available websites allow individuals and businesses to purchase the services of others, such as website design, computer programming, legal services, and others. However, the design of such websites is more accommodating to larger projects, such as the design and construction of an entire website, which typically involves significant and repeated interactions between the customer and the same service provider. Many of such projects are fixed-fee arrangements, whereby the customer pays a fixed amount for the work product of the service provider, e.g., a fixed fee for the design and construction of a website or consulting with a lawyer for a bankruptcy or divorce (regardless of the total amount of time required of the service provider to complete the project).

There has been, and continues to be, a need for on-line systems and methods that enable a customer to seek out and purchase the consulting services of an expert, whereby the amount of consulting services provided is relatively modest. In other words, the currently-available websites that operate as portals for service providers are unable to accommodate a customer who wishes to discuss an issue with a consultant for a short period of time, such as 15 minutes, 30 minutes, an hour, etc. Such small-scale type consulting arrangements are commonly referred to as “micro-consulting” transactions.

For these micro-consulting types of transactions, it would be preferred to have systems in place that allow the consultant to charge a consulting rate that is based on the actual amount of time spent rendering the consulting services. More particularly, there is a demand for on-line systems that employ a time metering function, whereby a customer agrees to pay a certain fee per unit time and, when the consultant is engaged, the time metering function records the total amount of time the consultant spends advising the customer. Still further, it would be desirable for such on-line systems to be compatible and interface with various instant messaging (IM) systems and Voice Over Internet Protocol (VoIP) systems that allow two persons to connect and communicate with one another.

As described further below, the present invention addresses many of the foregoing needs and demands for such methods and systems.

### SUMMARY OF THE INVENTION

According to a first preferred embodiment of the present invention, systems are provided that allow a customer to purchase and receive the services of a consultant. In such embodiments, the systems generally comprise an instant messaging (IM) application, which is capable of connecting a customer to a consultant. The systems further comprise an IM plugin, wherein the IM plugin is capable of detecting a message from the customer to the consultant sent through the IM application. The systems also include a server, wherein the server is capable of communicating with and receiving input from the IM plugin. Such input is processed by the server to validate the customer and instruct the IM plugin to connect the customer with the consultant through the IM application. The systems of the present invention allow customers to connect and communicate with consultants through readily available IM applications and other mediums, such as, but not limited to, telephony, Voice Over Internet Protocol (VoIP), text messaging, electronic mail, and video connections. In addition, the IM plugin and server work to record the amount of time during which the customer is connected to the consultant, such that the consultant may be compensated for the advice and services rendered on a per unit time basis.

According to certain related preferred embodiments of the present invention, methods for requesting, purchasing and receiving the services of a consultant are provided. In such embodiments, the methods comprise initiating a communication with a consultant through an instant messaging (IM) application, wherein an IM plugin is activated that (a) detects the communication from the customer to the consultant sent through the IM application and (b) communicates with and provides input to a server. The server processes the input to validate the customer and instructs the IM plugin to connect the customer with the consultant through the IM application. Similar to the other embodiments of the present invention, such methods allow customers to connect and communicate with consultants through readily available IM applications and other mediums and, furthermore, enable a consultant to be compensated for the advice and services rendered through such communications means on a per unit time basis.

According to further preferred embodiments of the present invention, methods and systems for requesting, purchasing and receiving the services of a consultant are provided. In such embodiments, the methods and systems comprise initiating a communication with a consultant through a communications means, wherein the communications means may consist of conventional telephony, VoIP, or an internet-mediated video connection. In such embodiments, a plugin housed in and utilized by a computer terminal controlled by the consultant is subsequently activated, whereby the plugin (a) detects the communication from the customer to the consultant sent through the communications means and (b) communicates with and provides input to a server. The server processes the input to validate the customer and instructs the plugin to connect the customer with the consultant through the communications means, e.g., through the VoIP or internet-mediated video connection.

Additional advantages of the invention will be set forth in the description that follows. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The above and other features and advantages of the present invention will become more apparent from the following description of the present invention taken in conjunction with the accompanying drawings, in which:

FIG. 1 is a non-limiting example of a logical data model for the systems and methods of the present invention.

FIG. 2 is a diagram summarizing a non-limiting example of the systems and methods of the present invention.

### DETAILED DESCRIPTION OF THE INVENTION

The present invention relates to systems and methods for requesting, receiving, providing, and paying for services, particularly consulting-type services, through IM applications, VoIP connections, and through other mediums. The following detailed description utilizes a number of terms and phrases which are generally well-known in the art or industry. For convenience, however, the following provides a brief definition for certain terms and phrases used herein.

The term “consultant” refers to any provider of advice or service, including individuals and businesses. Non-limiting examples of consultants that may be involved in or utilize the systems and methods of the present invention include, but are not limited to, attorneys, computer consultants, networking consultants, engineers, electronics specialists, scientists, health care providers, psychologists, business consultants, stock brokers, financial service providers, real estate agents, culinary experts, web designers, employment counselors, teachers, educational tutors, tax advisors, home improvement specialists, home repair specialists, and home decor experts.

The term “customer” refers to any individual or business that requests and/or receives the services and/or advice of any consultant, using the systems and methods described herein.

The terms “IM application” and “instant messaging (IM) application” refer to a multiprotocol instant messaging application that primarily consists of client software that may be used to connect to a plurality of IM networks, which enables two or more individuals to communicate in real-time based on typed text. Non-limiting examples of currently-available supported networks include AOL Instant Messenger, ICQ (an IM computer program), Jabber, including Google Talk, Gizmo, and other Jabber-based networks, MSN Messenger, QQ (Tencent QQ), Yahoo! Messenger, and other specialized and/or custom tailored networks, such as Novell GroupWise and Zephyr.

The term “IM plugin” refers to (1) a plugin that is capable of interacting and communicating with an IM application (or other communications means) and at least one server, whereby the IM plugin is used to carry out the specific functions described herein and/or (2) executable code that exists within, is considered a part of, or is otherwise used by an IM application to carry out the specific functions described herein. For the avoidance of doubt, those of ordinary skill in the art will appreciate that the IM plugins used in the present invention may exist separate and apart from an IM application or, alternatively, may exist within and be considered a part of an IM application.

The term “plugin” refers to a computer program (or executable code) that (1) is capable of interacting and communicating with a main (or host) application to provide the specific functions described herein and/or (2) exists within, is considered a part of, or is otherwise used by a main (or host) application to provide the specific functions described herein. Non-limiting examples of such main (or host) applications include an IM application, other communications means (such as VoIP or internet video connections), web browsers, server-based applications, database applications, and the like.

The terms “validate the customer,” “validates the customer,” and similar phrases refer to the process by which a server that is employed in the methods and systems described herein verifies that a customer has provided the server (e.g., via a website portal) with sufficient information such that the customer is deemed to be authentic and capable of purchasing services from a consultant. In other words, when the server “validates” a customer, the server may determine whether the customer has previously submitted the necessary registration information, which is necessary to use the methods and systems of the present invention to purchase services from consultants. As described further below, the invention provides that customers will register themselves with the server, preferably through a website portal, by providing information that identifies the customer (whereby such identifying information may comprise a customer's name, username, password, billing address, e-mail address, payment information, such as credit or debit card information, and/or other customer-specific information).

The terms “Voice Over Internet Protocol” and “VoIP” refer to communication means, including software, hardware, and combinations thereof, which enable the routing of voice conversations through the internet or through any other internet protocol- (IP-) based network. A non-limiting example of a current VoIP service provider is Skype (www.skype.com).

Other terms used, but not defined above, shall have the meanings ascribed thereto as expressly provided below, or as those skilled in the art or industry would understand such terms based on the context in which a particular term or phrase is used.

According to a first preferred embodiment of the present invention, systems are provided that allow a customer to request, purchase and receive the services of a consultant. In such embodiments, the systems generally comprise an instant messaging (IM) application, an IM plugin, and at least one server. The IM application will be capable of connecting a customer to a consultant, wherein the IM plugin is capable of detecting a connection (i.e., a message) from the customer to the consultant sent through the IM application. The invention further provides that the at least one server that is used in the systems is capable of communicating with and receiving input from the IM plugin. Such input is processed by the server to validate the customer, as defined above and otherwise described herein, and instruct the IM plugin to connect the customer with the consultant through the IM application.

The systems of the present invention allow customers to connect and communicate with consultants through readily available IM applications and other mediums, such as, but not limited to, telephony, Voice Over Internet Protocol (VoIP), text messaging, electronic mail, and video connections. In addition, the IM plugin and server work to record the amount of time during which the customer is connected to the consultant through the IM application, VoIP connection, or other communications means, such that the consultant may be compensated for the advice and services rendered on a per unit time basis, e.g., such as based on an hourly rate.

According to certain related preferred embodiments of the present invention, methods are provided for requesting, purchasing and receiving the services of a consultant. In such embodiments, the methods comprise initiating a communication with a consultant through an instant messaging (IM) application, wherein an IM plugin is activated that (a) detects the communication from the customer to the consultant sent through the IM application and (b) communicates with and provides input to a server. Similar to the other embodiments referenced above, the server processes the input to validate the customer and instructs the IM plugin to connect the customer with the consultant through the IM application. Such methods allow customers to connect and communicate with consultants through readily available IM applications and other mediums and, furthermore, enable a consultant to be compensated for the advice and services rendered on a per unit time basis.

In addition to (or in replace of) IM applications, the systems and methods of the present invention may employ other communication means, including without limitation conventional telephony, Voice Over Internet Protocol (VoIP), and internet-mediated video connections. Accordingly, further preferred embodiments of the present invention include methods and systems for requesting, purchasing and receiving the services of a consultant, which incorporate the use of other communications means, such as VoIP and internet-mediated video connections. In such embodiments, for example, the methods and systems comprise initiating a communication with a consultant through a communications means, wherein the communications means may consist of conventional telephony, VoIP, or an internet-mediated video connection (e.g., webcams, videoconferencing camera connections, and others). In such embodiments, a plugin housed in and utilized by a computer terminal controlled by the consultant is subsequently activated, whereby the plugin (a) detects the communication from the customer to the consultant sent through the communications means and (b) communicates with and provides input to a server. The server processes the input to validate the customer and instruct the plugin to connect the customer with the consultant through the communications means. Similar to the other embodiments described thus far, the plugin and server function to record the total amount of time the customer is connected to the consultant through the communications means (e.g., VoIP or internet-mediated video connection), such that the consultant may be compensated for the consulting session on a per unit time basis.

According to the embodiments described above, the invention provides that a consultant may instruct the IM plugin (or, for example, VoIP plugin) to accept or reject an attempted connection (message) from a customer. The consultant may accept or reject the message vis-à-vis computer- and/or telephonic-related means. The invention provides that if the consultant accepts the message from the customer, the plugin instructs the server to execute a usage module, wherein the usage module records an amount of time during which the customer is connected to the consultant through, for example, the IM application, VoIP connection, or other communications means.

In certain preferred embodiments of the present invention, the amount of time during which the customer is connected to the consultant through, for example, the IM application is converted into a fee amount, whereby such conversion is preferably processed by the server. The fee amount represents the monetary value that will be charged to the consultant in exchange for the consultant's services. Such fee amount may be calculated by multiplying the amount of time during which the customer is connected to the consultant through, for example, the IM application by the consultant's rate. For example, if the consultant's agreed-upon rate is $100 per hour, and the customer is connected to the consultant for 30 minutes through the IM application, the fee amount would be $50. The server will preferably convert the amount of time during which the customer is connected to the consultant into a fee amount and, optionally, communicate the fee amount through the plugin to the consultant and/or customer during (or shortly after) a consulting session.

The server will preferably deduct the fee amount from the customer's usage balance. The usage balance represents the total amount of fees that the customer has previously agreed to pay for services. More particularly, the usage balance may represent (a) the total amount of fees that the customer has previously agreed to pay for services rendered by a specific consultant, which are also referred to herein as “demand-paid” fees or accounts, or (b) the total amount of fees that the customer has previously agreed to pay for services rendered by a plurality of consultants (whereby such services may be rendered over the course of several days, weeks, or even years), which are also referred to herein as “pre-paid” fees or accounts. Preferably, the customer provides the server with the usage balance through a computer terminal.

A customer's usage balance may be specified within and/or provided to the server in any of various ways. For example, the customer may designate an amount of fees the customer is willing to pay for services (e.g., by specifying such amount through a website that transfers such information to a database housed within the server) and, following the receipt of such services, forward payment directly to the responsible consultant. In other embodiments, for example, the customer may deposit an amount of fees with an administrator or escrow agent, which holds the fees until the customer releases the fees to be paid to a consultant to whom such fees are owed (in compensation for services rendered). The means by which the customer may deposit an amount of fees with an administrator or escrow agent will be known to those of ordinary skill in the art. By way of illustration, however, the customer may deposit an amount using a debit card, credit card, bank account, credit union, or other payment methods well-known in the art or industry, whereby the information needed to charge the debit card, credit card, bank account or credit union may be entered by the customer through a secure and private webpage and provided to the server, whereby the server then processes such information to charge the customer through the appropriate gateway.

As used herein, “administrator” refers to any individual, business, and/or website that carries out, operates and manages the systems of the present invention. As described further below, the systems and methods of the present invention are particularly well-suited to be carried out in the form of a website. Thus, in many cases, the term “administrator” refers to the owner, operator, and/or manager of the website in which the systems and methods of the present invention are carried out.

According to certain preferred embodiments of the invention, the IM plugin receives real-time usage balance information from the server, wherein the IM plugin is capable of issuing a notice to the customer and consultant during a consultation session when the usage balance reaches a minimum threshold. Of course, the amount of the usage balance may represent the (a) amount that the customer previously agreed to pay for services as recorded in a database housed within the server and/or (b) an actual deposit of fees that the customer has made with, for example, an administrator or escrow agent (whereby the amount of such deposit is recorded and accessible within a database that is housed within the server). Still further, the invention provides that the IM plugin may operate to terminate the connection between the customer and consultant when the usage balance equals zero. Alternatively, the IM plugin may operate to notify the customer and consultant that the allotted duration for the consultation session has expired and, as such, subsequent time during which the customer is connected to the consultant will be billed separately.

The invention provides that the server may further execute one or more business rules before connecting a customer with a consultant through, for example, an IM application. More particularly, the server may first “validate the customer,” as described herein, by verifying that the customer has previously provided the server with sufficient registration and customer-identifying information. Next, the server may execute one or more business rules. As used herein, the term “business rule(s)” generally refers to a condition (or set of conditions) that must be satisfied in order for an IM plugin (or other plugin used in the present invention) to connect a customer with a consultant. In many cases, such conditions are established by a consultant.

For example, the server may execute a business rule that verifies that a customer is of sufficient age to enter into legally binding contracts with consultants by requiring the customer to execute an electronic agreement, which provides that the customer swears that he/she is of a certain minimum age. In addition, the server may execute a business rule that verifies that the customer's usage balance is equal to or greater than a minimum balance, wherein the minimum balance represents the total amount of fees the customer will be invoiced for connecting to a particular consultant for a duration of time requested by the customer. In addition, for example, the server may execute a business rule that verifies that the preferred languages of the customer and consultant are compatible, e.g., that both the customer and consultant are fluent in at least one common language. Still further, the server may execute a business rule that confirms that a consultant is available on the particular day and time when (a) the customer requests the services of a consultant or (b) attempts to initiate a connection with the consultant through an IM application or other communications means (i.e., in the form of a “walk-in” type consulting session). In order for the server to carry out such business rules and verification steps, the consultant will have previously provided the server with, for example, the languages with which the consultant is fluent, a set of dates and times when the consultant will be available for consultation sessions, whether the consultant accepts “walk-in,” i.e., unscheduled, consultation sessions, etc.

The invention provides that a consultant may be paid for his/her services based on (1) a block of time, e.g., 15 minute, 30 minute, or 60 minute blocks of time, or (2) for an open-ended period of time, whereby the total amount due will be the product of the length of time during which the customer is connected to a consultant and the consultant's rate. When a consultant wishes to be paid for services rendered in “blocks” of time, when a connection is initiated through, e.g., an IM application, the IM plugin instructs the server to execute the usage module. The usage module will monitor and record the length of the consulting session and (a) issue notices (through the plugin) to the customer and consultant when the full block of time has almost expired, (b) terminate the connection when the full block of time has expired, and/or (c) allow the connection to continue after the full block of time has expired (and preferably issue a notice to the customer and consultant that such additional time will be billed separately by the consultant). The notices issued by the plugins, as described herein, may be implemented through the communications means being used by the customer and consultant, such as in the form of a text message through an IM application or automated voice message through a VoIP connection (the content of such notices being sourced from the server).

Still further, when a consultant wishes to be paid for services rendered in blocks of time, the plugin may optionally allow the customer and/or consultant to extend the duration or length of the block of time, during the course of a consulting session. In addition, when a consultant wishes to be paid for services rendered in blocks of time, if a customer voluntarily ends a consulting session before the expiration of the previously-designated block of time, the customer may be required to pay (a) only a pro rata share of the length of the consulting session or (b) the full amount for the previously-designated block of time (whereby the customer forfeits the unused portion of the consulting session).

As described herein, the systems and methods of the present invention employ an IM plugin, which communicates with a server and the consultant's IM application. As those of ordinary skill in the art will appreciate, a plugin may also be used in constructing and using the systems and methods of the present invention, whereby such plugin communicates with a server and the consultant's specified communications means, such as VoIP or internet-mediated video connections. In all cases, the plugins will be controlled by the consultant, and is preferably housed within a computer terminal that is used by the consultant. Such plugins may be provided to the consultant's computer terminal by downloading the same through the internet, or through any other readily-available delivery mechanisms.

As described above, the systems and methods of the present invention are particularly well-suited to being implemented and carried out in the form of a website. For example, the invention provides that such a website may consist of multiple segments, whereby a first segment is publicly accessible and a second segment is only accessible to those customers and consultants that wish to utilize the systems and methods of the present invention. More particularly, the invention provides that a publicly accessible segment of the website may list and describe various consultants who are available to render services. The website preferably enables each such consultant to establish a profile page, which describes the types of services offered by the consultant, the consultant's credentials, and, optionally, feedback that customers have left regarding the quality of consultant's services. In addition, the profile page may allow a consultant to publish pictures and other items that customers may wish to review before engaging a consultant. Still further, a consultant's profile page may list (a) the consultant's rates (which may be constant across all IM applications and/or other communications means or may vary, e.g., a higher rate may be charged for consulting sessions carried out through video means), (b) the types of consulting sessions the consultant is willing to accept (e.g., the minimum amount of time or fees the consultant is willing to accept for a consulting session), (c) whether the consultant accepts “walk-in” (i.e., unscheduled) consultation sessions (in which case the consultant's IM application, for example, must be in an available state) or only scheduled consultation sessions, (d) the days and times of the consultant's availability, (e) the preferred language(s) of the consultant, (f) the consultant's preferred IM or VoIP applications, (g) whether the consultant is willing to provide any free consulting (such as for the purpose of introducing the consultant to a customer and allowing the customer to decide whether to engage the consultant) and, if so, the amount of free time the consultant is willing to provide, and/or (h) other information that a consultant may wish to publish within a profile page. Similarly, the website may enable customers to publish profile information regarding themselves, which may be supplemented with buying history and consultant feedback by the customer and/or website administrator.

The website preferably allows customers to query the contents of the consultant profile pages, such that a customer may quickly identify consultants that (a) offer certain types of services (e.g., web design, legal services, tax advice, etc.), (b) charge a rate within the customer's specified budget or range, (c) are available on a particular day and time (or sets of dates and times), (d) are located within a particular geographical area, (e) are fluent in a particular language, (f) offer “walk-in” sessions, (g) are amenable to a particular IM or VoIP application, and/or (h) other information.

A website that implements the systems and methods of the present invention may further allow consultants to designate a login username and password, whereby such username and password may be entered within the website, processed by the server described herein, and used to permit access to a private segment of the website (referred to herein as the “Consultant Account Page”). The Consultant Account Page may list the total amount of fees collected by the consultant, a history of all consulting sessions conducted, a listing of scheduled consulting sessions that have been requested by customers, a listing of upcoming scheduled consulting sessions, the amounts owed by the consultant for having access to and being entitled to use the website (whereby such amount may be owed to the administrator of the website), the consultant's debit card, credit card, or bank account information (for use in making such payments to the administrator), and other consultant-specific information. The Consultant Account Page may further allow the consultant to populate and revise his/her profile page. The invention provides, of course, that such Consultant Account Page will only be accessible to a particular consultant, which is implemented by issuing a unique login and password to each such consultant (or otherwise allowing each consultant to specify the login and password data, which are verified by the server to be unique before being accepted).

The invention provides that the fees owed by a consultant to an administrator of the website may be charged in various ways. According to a first method, the administrator may receive all fees owed to consultants by customers, whereby the administrator retains a commission (such as in the form of a percentage of fees paid to the consultant) and transfers the balance to the consultant. In a second method, a customer may, directly or indirectly, pay the consultant the fees owed for a consulting session, whereby the consultant is allowed to retain all of such fees. In such case, the administrator may then issue an invoice to the consultant (payable within a defined period of time) for a commission (such as in the form of a percentage of fees paid to the consultant), in which case the consultant then remits payment to the website administrator. In a third method, the administrator may charge a consultant a fixed fee on a regular and recurring basis, whereby such fixed fee allows the consultant to use and be an active member within the website. In a fourth method, the administrator may charge fees using any combination of the foregoing.

Similar to the Consultant Account Pages, the invention provides that the website may further allow customers to designate a login username and password, whereby such username and password may be used to access a private segment of the website (referred to herein as the “Customer Account Page”). The Customer Account Page may list the total amount of fees paid by the customer, a history of all consulting sessions requested and paid for by the customer, a listing of scheduled consulting sessions that the customer has requested from consultants, a listing of upcoming scheduled consulting sessions, the amounts owed by the customer in exchange for services rendered by one or more consultants (and the dates on which such amounts are due), the customer's debit card, credit card, or bank account information (for use in making such payments to consultants, an administrator, or to an escrow agent), and other consultant-specific information. The invention further provides that the website administrator may charge customers transaction-based (i.e., consulting session-based) fees or recurring fixed-fees in exchange for being entitled to use the website.

The present invention, or “e-Consultant marketplace,” has been shown to provide an efficient and cost-effective means for customers to purchase, and consultants to provide, micro-consulting types of services. As described herein, the methods and systems of the present invention, particularly as implemented in the form of a website, allow consultants to advertise their services in a categorized community, which customers may quickly browse and engage consultants who meet their needs. In addition, the methods and systems of the present invention, particularly as implemented in the form of a website, are flexible insofar as they allow customers to set up both pre-paid and demand-paid accounts.

More particularly, for example, a pre-paid account would represent a deposited amount of fees that the customer will spend over time for micro-consulting sessions using the methods and systems described herein, whereby the micro-consulting sessions may involve a plurality of different consultants (across a range of expertise). As described herein, in certain embodiments of the invention, the length of one or a combination of consulting sessions may be limited to the amount of fees deposited in such a pre-paid account, which is also described herein as a usage balance. In contrast, a demand-paid account may allow a customer to request, purchase, and receive the services of a specific consultant, whereby the length of the consulting session may be limited (e.g., in the form of a purchased block of time) or unlimited (in which case the customer will be required to pay the full amount owed, i.e., the product of the length of the session and the consultant's rate).

The following examples are provided to further illustrate the systems and methods of the present invention. These examples are illustrative only and are not intended to limit the scope of the invention in any way.

### EXAMPLES

### Example 1

### Logical Data Model for On-Line “Marketplace”

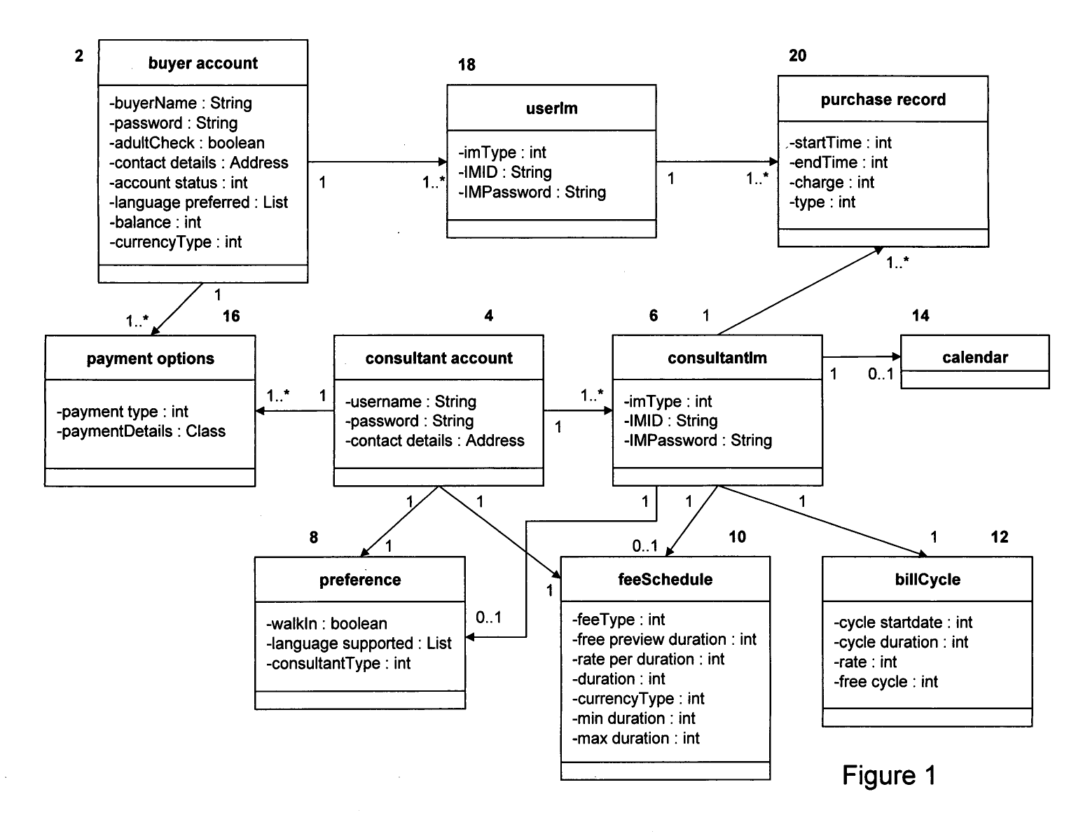

The following represents a non-limiting example of a logical data model, particularly illustrating a logical data model for an on-line “marketplace” in which the systems and methods of the present invention are employed. The logical data model described and shown herein particularly relates to the general architecture of a server that may be used in the present invention and the relationships of the data entities shown therein. Referring to FIG. 1, for example, a logical data model is presented which shows the types of data a customer (referred to as a “buyer” therein) and consultant will provide to a system of the present invention. As described above, such information is preferably provided to a server using an internet-connected computer terminal, whereby the server houses a database that organizes and makes available such data and related information for use with the plugins and other methods and systems described herein.

Referring to FIG. 1, Box 2 shows the logical data for creating a buyer account, whereby “buyerName” represents a username selected by the buyer, “password” represents a secret password selected by the buyer, “adultCheck” represents an indication as to whether a buyer has passed an adult check (whereby the rules governing whether the buyer is an “adult” may be influenced by the country in which the buyer is located or the type of services which the buyer wishes to purchase), “contact details” represents the buyer's address information, and “account status” represents an indication as to whether the status of the buyer is designated as “verified”, “hold” or “pending” (whereby “verified” indicates that the buyer as provided sufficient evidence of identity and/or payment information to be allowed to purchase services, “hold” indicates that certain evidence, information, or money needs to be provided or updated by the buyer, or confirmed by a systems administrator, before the buyer will be allowed to purchase services, and “pending” indicates that certain evidence, information, or money needs to be confirmed by a systems administrator before the buyer will be allowed to purchase services). Still referring to Box 2 in FIG. 1, “language preferred” indicates the languages understood and/or preferably used by the buyer, such that the buyer may preferably select a consultant with a compatible language background, “balance” represents the buyer's current cash balance for use in purchasing and paying for services, i.e., a form of “usage balance” referred to above, and “currency type” represents the type(s) of currency the buyer is able to and/or prefers to use as compensation for services rendered.

Box 4 of FIG. 1 represents the logical data that a consultant may provide to a server via a computer terminal to establish a consultant account, whereby “username” represents a username selected by the consultant, “password” represents a secret password selected by the consultant, and “contact details” represents the address information of the consultant.

Box 6 of FIG. 1 represents the logical data for a consultant's IM application (client), whereby such consultant may have one or more preferred IM applications (clients). As shown in Box 6, “imType” represents the type of IM application that the consultant employs, “IMID” represents the consultant's login identification code (or login information) for the IM application, and “IMPassword” represents the consultant's password for the IM application.

Box 8 of FIG. 1 represents the logical data for the preferred consultation attributes that a consultant may assign, whereby “walkIN” represents an indication as to whether the consultant is willing to engage in unscheduled consultations with buyers (customers)(a.k.a. “walk in” consultations), wherein a “true” indicator means the consultant accepts unscheduled consultations, whereas a “false” indicator means the consultant does not accept unscheduled consultations (and that all consultations must satisfy the logical data contained in Box 14, discussed below, relating to the consultant's availability). Still referring to Box 8 of FIG. 1, “language supported” represents the language(s) with which the consultant is fluent and/or the language(s) the consultant is willing and able to use during a consultation, and “consultantType” represents whether the content of the consultant's services are adult-oriented and/or for limited audiences.

Box 10 of FIG. 1 represents the logical data that is used to calculate the amount of fees to be charged to a buyer in exchange for the consultant's services. The invention provides that the formula used to calculate the amount due may be the same across all IM applications or, alternatively, may vary among IM applications (e.g., for IM applications having different rate plans) or adjusted on a case-by-case basis. Still referring to Box 10 of FIG. 1, “feetype” represents whether the consultation will be carried out via textual, audio, and/or video means, “free preview duration” represents whether the consultant offers any preliminary free consulting (such as for first-time buyers) and, if so, the duration of such free consulting, “rate per duration” represents the fee charged by the consultant in exchange for services on a per unit time basis (e.g., $100 per hour, $2.00 per minute, etc.), “duration” represents (i) the unit(s) of time during which the consultant is willing to provide services (e.g., per minute, 5 minute periods, 15 minute periods, half-hour periods, hour periods, etc.) and/or (ii) the duration of time a consultant has agreed to provide services, “currencyType” represents the type(s) of currency the consultant accepts in exchange for services, “min duration” represents the minimum amount of time during which the consultant is willing to provide services, and “max duration” represents the maximum amount of time during which the consultant is willing to provide services.

Box 12 of FIG. 1 represents the logical data for the recurring charge that a consultant must pay to remain a member of the on-line marketplace, as described above, whereby “cycle startdate” represents the first day of each payment period (wherein each payment entitles the consultant to use and be a member of the marketplace (e.g., website) for the defined cycle duration), “cycle duration” represents the period of time during which a consultant is entitled to use and be a member of the marketplace (e.g., website) in exchange for the defined rate (or payment), “rate” represents the amount charged (billed) to the consultant for an entire cycle duration, and “free cycle” represents an amount of time, beginning on the “cycle startdate,” during which the consultant is entitled to use and be a member of the marketplace (e.g., website) free of charge.

Box 14 of FIG. 1 represents the logical data for the availability of a consultant, which is considered for scheduled consultations. For schedule consultations, a consultant may specify specific dates and times during which the consultant would be available for a scheduled consultation or, alternatively, a set of recurring dates and times (in each calendar month) when the consultant would be available for a consultation.

Box 16 of FIG. 1 represents the logical data for the payment option(s) available for consultants (to pay the “rate” for a “cycle duration”) and buyers (to pay or pre-pay for services rendered by a consultant). In Box 16, “payment type” represents the types of payment methods available, such as debit cards, credit cards, credit union accounts, bank accounts, PayPal accounts, Google Checkout accounts, and others, and “paymentDetails” represents information that must be provided by a consultant or buyer to activate and utilize each “payment type,” such as debit and credit card numbers and expiration dates, checking account numbers and routing numbers, account usernames and passwords, and other payment-related information. Still referring to FIG. 1, Box 18 is used and populated with logical data if a buyer elects to use or have available more than one IM application.

Box 20 of FIG. 1 represents the logical data for a buyer's purchase record, which is used to track, record, and publish a buyer's purchase of services and, furthermore, a real-time account of the buyer's usage balance (as described above). Referring to Box 20, “startTime” represents the day and time on which a consultation session begins, “endTime” represents the day and time on which a consultation session ends, “charge” represents the total amount of fees to be charged against the buyer in exchange for the consultant's services (which may represent (a) the product of (the difference between “startTime” and “endTime”) and the consultant's specified “rate per duration”) or (b) the product of the “duration” and the consultant's specified “rate per duration”). Still referring to Box 20 of FIG. 1, “type” represents whether the consultation session will be considered and billed as a “pre-paid” or “demand-paid” purchase, as such arrangements are described above.

### Example 2

### Consulting Session

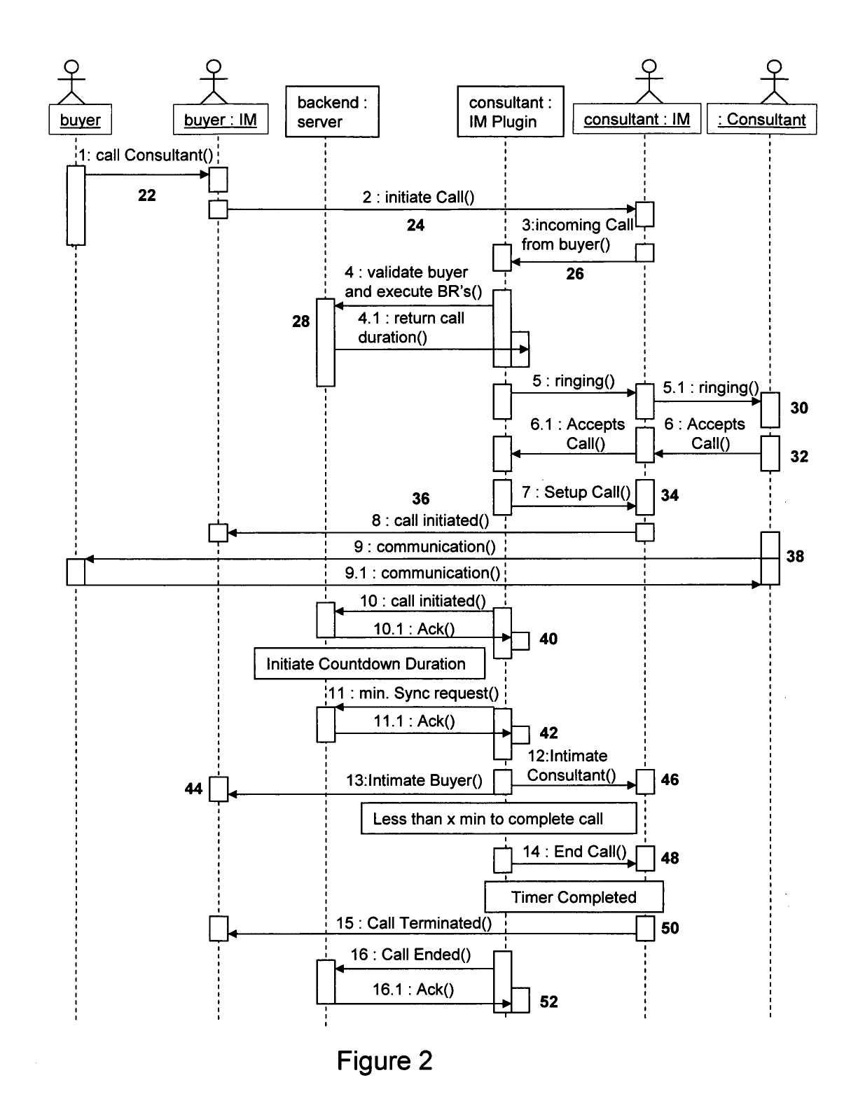

The following represents a non-limiting example of the process by which a customer (buyer) requests, receives, and purchases the services of a consultant, using the systems and methods of the present invention. To begin, and referring to FIG. 2, the buyer initiates a communication with a consultant through an IM application 22, whereby the buyer's IM application initiates a connection with the consultant's IM application 24. The consultant's IM plugin intercepts the connection between the buyer's and consultant's IM applications 26.

The IM plugin then communicates with a server, whereby the IM plugin provides the server with certain buyer-specific information, such as the buyer's IM client username (ID) and/or other buyer-specific information 28. The server then attempts to validate the buyer (customer). If the server is able to validate the buyer, such as when the buyer has been properly registered with the server, the server may then execute one or more business rules. For example, the server may determine whether the buyer's usage balance is sufficient to purchase the services of the consultant for the desired period of time, whether the consultant is available on the day and time when the buyer initiates the connection (in the case of unscheduled sessions), whether the language preference of the consultant is compatible with that of the buyer, and/or other business-, buyer-, or consultant-specific criteria 28. If the server is able to validate the buyer and the applicable business rules are satisfied, the IM plugin allows the connection to made (i.e., it allows the call or message to go through to the consultant) 30. At this point, the consultant may accept or reject the call 32.

If the consultant accepts the call 32, the IM plugin sends a message to the consultant's IM application to setup a call 34 and establish a connection with the buyer's IM application 36. At this point, the buyer and consultant are allowed to communicate and begin the consultation session 38. The IM plugin notifies the server that the consultation session (i.e., the call) has been initiated. In response, the server executes a script that measures and records the “duration” of the consultation session 40 (shown in FIG. 2 as “Ack Plugin”). The IM plugin may, optionally, periodically communicate with the server to verify that a consulting session is still active. The server may also provide the IM plugin with (i) the amount of time left for the consultation period (i.e., the current balance of the “duration”) 42 for sessions that are scheduled to begin and end at certain times (or for sessions consisting of a fixed period of time) or, alternatively, the total amount of time the consultation session has been active (if, for example, the session is not limited to a particular time endpoint or fixed period of time). The IM plugin may communicate the foregoing information 42 to the buyer 44 and consultant 46.

For consulting sessions of a fixed “duration,” once the consulting session has been active for the full “duration,” the IM plugin sends an end-call notification to the consultant's IM application 48. In this Example, the consultant's IM application then terminates the connection with the buyer's IM application 50. At this point, the IM plugin notifies the server that the consultation session has ended, whereby the server then updates the usage records, including usage balance and other data, to reflect the amount of consulting time and fees charged for the consulting session 52.

Although the foregoing invention has been described in detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims. In the claims, elements and/or steps do not imply any particular order of operation, unless explicitly stated in the claims (or the context otherwise requires a particular order of operation).

What is claimed is:

1. A system that allows a customer to purchase and receive the services of a consultant, which comprises:
(a) an instant messaging (IM) application, which is capable of connecting a customer to a consultant;
(b) an IM plugin, wherein the IM plugin is capable of detecting a message from the customer to the consultant sent through the IM application; and
(c) a server, wherein the server is capable of communicating with and receiving input from the IM plugin, wherein said input is processed by the server to validate the customer and instruct the IM plugin to connect the customer with the consultant through the IM application.

2. The system of claim 1, wherein the consultant may instruct the IM plugin to accept or reject the message from the customer, wherein if the consultant accepts the message from the customer, the IM plugin instructs the server to execute a usage module, wherein the usage module records an amount of time during which the customer is connected to the consultant through the IM application.

3. The system of claim 2, wherein the amount of time is converted into a fee amount, wherein the server deducts the fee amount from a usage balance, wherein the usage balance represents a total amount of fees the customer has previously agreed to pay for services.

4. The system of claim 3, wherein the customer provides the server with the usage balance through a computer terminal, wherein the usage balance represents the total amount of fees the customer has previously agreed to pay for services rendered by a specific consultant or a plurality of consultants.

5. The system of claim 4, wherein the IM plugin receives usage balance information from the server, wherein the IM plugin is capable of issuing a notice to the customer and consultant when the usage balance reaches a minimum threshold, and wherein the IM plugin terminates the connection between the customer and consultant when the usage balance equals zero.

6. The system of claim 4, wherein the server executes a business rule which verifies that the customer's usage balance is equal to or greater than a minimum balance, wherein the minimum balance represents the total amount of fees the customer will be invoiced for connecting to the consultant for a duration of time requested by the customer.

7. The system of claim 4, wherein the server executes a business rule which verifies that the consultant is available on the day and time that the customer initiates a connection through the IM application, wherein the consultant has previously provided the server with a set of dates and times on which the consultant is available using a computer terminal.

8. The system of claim 2, wherein if the consultant accepts the message from the customer, the IM plugin instructs the server to execute a usage module, wherein (i) the usage module records an amount of time during which the customer is connected to the consultant through the IM application, (ii) said amount of time is not limited to an upper threshold and (iii) the customer will be invoiced for the total amount of time during which the customer is connected to the consultant.

9. A method for purchasing and receiving the services of a consultant, which comprises initiating a communication with a consultant through an instant messaging (IM) application, wherein an IM plugin is activated that:
(a) detects the communication from the customer to the consultant sent through the IM application; and
(b) communicates with and provides input to a server, wherein said input is processed by the server to validate the customer and instruct the IM plugin to connect the customer with the consultant through the IM application.

10. The method of claim 9, wherein the consultant may instruct the IM plugin to accept or reject the message from the customer, wherein if the consultant accepts the message from the customer, the plugin instructs the server to execute a usage module, wherein the usage module records an amount of time during which the customer is connected to the consultant through the IM application.

11. The method of claim 10, wherein the amount of time is converted into a fee amount, wherein the server deducts the fee amount from a usage balance, wherein the usage balance represents a total amount of fees the customer has previously agreed to pay for services.

12. The method of claim 11, wherein the customer provides the server with the usage balance through a computer terminal, wherein the usage balance represents the total amount of fees the customer has previously agreed to pay for services rendered by a specific consultant or a plurality of consultants.

13. The method of claim 12, wherein the server further executes a business rule, whereby the business rule:
(a) verifies the customer's usage balance is equal to or greater than a minimum balance, wherein the minimum balance represents the total amount of fees the customer will be invoiced for connecting to the consultant for a duration of time requested by the customer;
(b) verifies that the consultant is available when the customer initiates a communication through the IM application, wherein the consultant has previously provided the server with a set of dates and times on which the consultant is available using a computer terminal; or
(c) a combination of the foregoing.

14. The method of claim 10, wherein if the consultant accepts the message from the customer, the plugin instructs the server to execute a usage module, wherein (i) the usage module records an amount of time during which the customer is connected to the consultant through the IM application, (ii) said amount of time is not limited to an upper threshold and (iii) the customer will be invoiced for the total amount of time during which the customer is connected to the consultant.

15. A method for purchasing and receiving the services of a consultant, which comprises initiating a communication with a consultant through a communications means selected from the group consisting of VoIP and an internet-mediated video connection, wherein a plugin is subsequently activated that:
(a) detects the communication from the customer to the consultant sent through the communications means; and
(b) communicates with and provides input to a server, wherein said input is processed by the server to validate the customer and instruct the plugin to connect the customer with the consultant through the communications means.

16. The method of claim 15, wherein the consultant may instruct the plugin to accept or reject the communication from the customer, wherein if the consultant accepts the communication from the customer, the plugin instructs the server to execute a usage module, wherein the usage module records an amount of time during which the customer is connected to the consultant through the communications means.

17. The method of claim 16, wherein the amount of time is converted into a fee amount, wherein the server deducts the fee amount from a usage balance, wherein the usage balance represents a total amount of fees the customer has previously agreed to pay for services.

18. The method of claim 17, wherein the customer provides the server with the usage balance through a computer terminal, wherein the usage balance represents the total amount of fees the customer has previously agreed to pay for services rendered by a specific consultant or a plurality of consultants.

19. The method of claim 18, wherein the server further executes a business rule, whereby the business rule:
(a) verifies the customer's usage balance is equal to or greater than a minimum balance, wherein the minimum balance represents a total amount of fees the customer will be invoiced for connecting to the consultant for a duration of time requested by the customer;
(b) verifies that the consultant is available when the customer initiates a communication through the communications means, wherein the consultant has previously provided the server with a set of dates and times on which the consultant is available using a computer terminal; or
(c) combinations of the foregoing.

20. The method of claim 16, wherein if the consultant accepts the message from the customer, the plugin instructs the server to execute a usage module, wherein (i) the usage module records an amount of time during which the customer is connected to the consultant through the communications means, (ii) said amount of time is not limited to an upper threshold and (iii) the customer will be invoiced for the total amount of time during which the customer is connected to the consultant.
